(19) United States
(12) Patent Application Publication
(10) Pub. No.: US 2008/0184566 A1
(43) Pub. Date: Aug. 7, 2008

(54) Replaceable blade offset snips

(75) Inventor: Stephen D. Deter, Sturgis, MI (US)

Correspondence Address: KREMBLAS, FOSTER, PHILLIPS & POLLICK, 7632 SLATE RIDGE BOULEVARD, REYNOLDSBURG, OH, 43068, US

(73) Assignee: Midwest Tool and Cutlery Company

(21) Appl. No.: 11/701,190

(22) Filed: Feb. 1, 2007

(51) Int. Cl. B23D 29/02

(52) U.S. Cl. 30/252

(57) ABSTRACT

A handheld cutting snips having offset blades and bent levers, as well as replaceable blade and thrust bearing members. Bent levers and offset blades allow material being cut to pass through the cutting blades of the snips and bypass the levers without interfering with the levers or the hands of the snips' operator. Replaceable blade-bearing members allow simultaneous replacement of the snips' blades and surfaces surrounding the snips' pivot point, thereby preventing uneven wear and eventual blade interference and/or misalignment of the levers.

### (e) BACKGROUND OF THE INVENTION

1. Field of the Invention

The present invention relates generally to the field of cutting tools and more particularly to hand-operated snips and shears for cutting sheet metal or other stiff or rigid material.

2. Description of the Related Art

Metal cutting snips have been used in industry for many years. Conventional snips are typically constructed of two pivotally connected levers. Each lever has two lever arms extending in generally opposite directions from a pivot. One lever arm of each lever has a cutting blade at its end and the other lever arm of each lever has a hand grip at the opposite end. The hand grip lever arm is sometimes referred to as a handle.

As with many types of snips, shears, and scissors, it is widely recognized that a substantial drawback associated with conventional snips is an unnecessarily short life span due to the cumulative wear on portions of the tool that engage the material being cut and that bear against and frictionally slide over each other during use. These engaging portions include the cutting edges of the blades, the opposing, inwardly-facing surfaces of the blades, and the opposing, inwardly-facing, thrust bearing surfaces of the tool that surround its pivot. Wear on the cutting edges of the blades results in dullness while wear on the opposing, inwardly-facing surfaces of the blades and thrust bearing surfaces surrounding the pivot causes a narrowing of the levers where those surfaces bear against each other. As the levers narrow, they move toward each other to close any gap between them, particularly if the pivot has a nut that can be tightened to hold the levers together.

Over time, the cumulative wear on the bearing surfaces leads to diminished performance and difficult operation of the snips. Because the bearing surfaces of conventional snips cannot be replaced independently of the rest of the tool, replacement of the entire tool eventually becomes necessary. Replacing the tool is costly and wasteful because those portions of the tool that do not experience significant wear must be discarded along with those that do.

A number of snips, shears, and scissors have been developed that have features which mitigate the problem of wear and poor longevity. For example, snips having replaceable blades were developed to allow removal and replacement of worn blades while preserving the rest of the tool for continued use. While such snips provide a more economical way to maintain a tool with sharp cutting edges, they do not provide a solution that addresses a problem that arises because of wear on the thrust bearing surfaces of the tool that surround its pivot.

Unlike the cutting edges and inwardly-facing surfaces of the blades that are replaced by replaceable blades, if only the blades are replaceable, the inwardly-facing surfaces surrounding the pivot of a snips cannot be independently replaced and will continue to wear throughout the life of the tool. This results in greater wear and narrowing of the lever arms around the pivot in comparison to the cumulative wear and narrowing occurring on each successive set of replacement blades. When new replacement blades are mounted to the lever arms of the snips, they will have no wear but the thrust bearing surfaces will have the cumulative previous wear. Consequently, when the blades are replaced, the levers of the snips will have moved toward each other by the amount of the cumulative wear of both thrust bearing surfaces to maintain contact between the thrust bearing surfaces. However, contact of the worn thrust bearing surfaces will cause the new, unworn blades to overlap and therefore interfere with each other. In the event that, as the snips are closed during a cutting operation, the blades are able to move apart sufficiently that they can slide over each other, they will force the thrust bearing surfaces around the pivot to move apart and have a space between them. Moving the thrust bearing surfaces apart permits misalignment of the levers of the snips. Again, it will be necessary to replace the entire tool to avoid such interference and misalignment.

Snips having both replaceable blades and replaceable thrust bearing surfaces surrounding the pivot eliminate the problem of uneven narrowing and resulting interference or misalignment. The prior art shows a snips in which all of the bearing surfaces on each of the levers of such a tool reside on a single, unitary body that may be independently removed from the snips. Therefore, all of the bearing surfaces on a lever can be replaced simultaneously. The result is that none of the bearing surfaces on either lever of the tool will accumulate a greater amount of wear than any other bearing surface on the same lever, thereby preventing uneven narrowing.

However, another drawback associated with conventional snips is that the material being cut can often interfere with the snips and the hand of the tool's operator as the blades move along the material during a cutting operation. This interference occurs because one or both levers of conventional snips, and sometimes the hand of the operator, are aligned so they intersect a cutting plane that extends through the cut and perpendicular to the material being cut. Consequently, the cut material on one or both sides of the cut will strike at least one lever of the snips. To avoid this interference, the operator is typically forced to hold the snips at an angle above or below the subject material and/or bend the material on one side of the cut to avoid the interference. This results in awkward and cumbersome operation and sometimes can not be done when cutting stiff materials.

To address the separate problem of this interference between the material being cut and the snip levers and/or the operator's hand, snips that are both offset and bent have been developed to allow effective operation of the tool without hindrance from the material being cut. Blades of snips are offset by positioning the blade lever arms away from the hand grip lever arms in a direction parallel to the pivot axis so that the cutting plane along which the blades move during a cutting operation is laterally beside both hand grip lever arms of the snips. By offsetting the blades from the cutting plane so that the cutting plane does not intersect the hand grip lever arms, the material on one side of the cut passes by the hand grip lever arms. Each of the levers is also bent so that each blade lever arm extends at an obtuse angle to its connected hand grip lever arm rather than in a 180°, diametrically opposite direction. This allows the cut material on the other side of the cut to pass under or over the hand grip lever arms. Offset and bent hand grip lever arms prevent the tool and the hands of the tool's operator from interfering with the material being cut, allowing the material being cut to bypass the tool and the operator's hands without interference.

While the issues of tool wear, longevity and lever arm interference with the material being cut have been addressed by the prior art, a need exists for snips that are able to not only have the features of being offset and bent, but simultaneously also have both replaceable blades and replaceable thrust bearing surfaces so that the snips not only avoid interference of the cut material with the snips and the operators hands, but also allow the blades to be replaced while simultaneously replacing the thrust bearing surfaces so that the replacement blades will align properly and not interfere with each other.

It is therefore an object and feature of the present invention to provide a snips having replaceable blades and replaceable thrust bearing surfaces for snips having offset blades and bent levers.

A further object and feature of the invention is to provide offset and bent snips that have a single, integral replacement component for each lever that allows both the blade and the thrust bearing surface to be conveniently replaced as a single, integral unit despite the fact that the blades and the thrust bearing surface are offset in spaced, parallel planes.

### (f) BRIEF SUMMARY OF THE INVENTION

The present invention provides a hand tool having two levers pivotably connected by a pivot fastener. Each lever has a blade lever-arm and a hand grip lever arm that extend in generally opposite directions from the pivot fastener. Each blade lever-arm is offset relative to each hand grip lever arm and each lever is bent. Each lever has a replaceable blade-bearing member conformingly seating against it. Each blade-bearing member is an elongated unitary body having a blade portion and a bearing portion. The blade portion of a blade-bearing member has a cutting edge and an inwardly-facing blade surface, both of which oppose and are engagable with the blade portion of the blade-bearing member on the other lever. The bearing portion of the blade-bearing member has a thrust-bearing surface surrounding the pivot and rotatably engaging the thrust-bearing surface of the blade-bearing member on the other lever. Importantly, the bearing portion is offset from and joined to the blade portion by two, oppositely-directed bends such that a blade-bearing member conformingly mates with the offset contour of a blade lever-arm and its connected hand grip lever arm.

During operation, the offset and bent configuration of the snips allows material to pass through the blades and bypass the levers without interference and the configuration of the integral blade-bearing member with its bearing portion offset from and joined to its blade portion by two, oppositely-directed bends allows fast, easy, and simultaneous replacement of all of the cutting edges and the thrust bearing surfaces of a snips having an offset and bent configuration.

### (g) BRIEF DESCRIPTION OF THE SEVERAL VIEWS OF THE DRAWINGS

FIG. 1 is a left-side perspective view of the preferred embodiment of the offset snips of the present invention shown in the closed position.

FIG. 2 is a right side perspective view of the snips shown in FIG. 1.

FIG. 3 is a right side elevational view of the snips shown in FIG. 1.

FIG. 4 is a left side elevational view of an embodiment of the snips shown in FIG. 1.

FIG. 5 is a top elevational view of an embodiment of the snips shown in FIG. 1.

FIG. 6 is a left-side perspective view of the right lever of the snips shown in FIG. 1.

FIG. 7 is a left-side perspective view of the right blade-bearing member of the snips shown in FIG. 1.

FIG. 8 is a left-side perspective view of the left blade-bearing member of the snips shown in FIG. 1.

FIG. 9 is a left-side perspective view of the left lever of the snips shown in FIG. 1.

FIG. 10 is a right-side perspective view of the left lever of the snips shown in FIG. 1.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### (h) DETAILED DESCRIPTION OF THE INVENTION

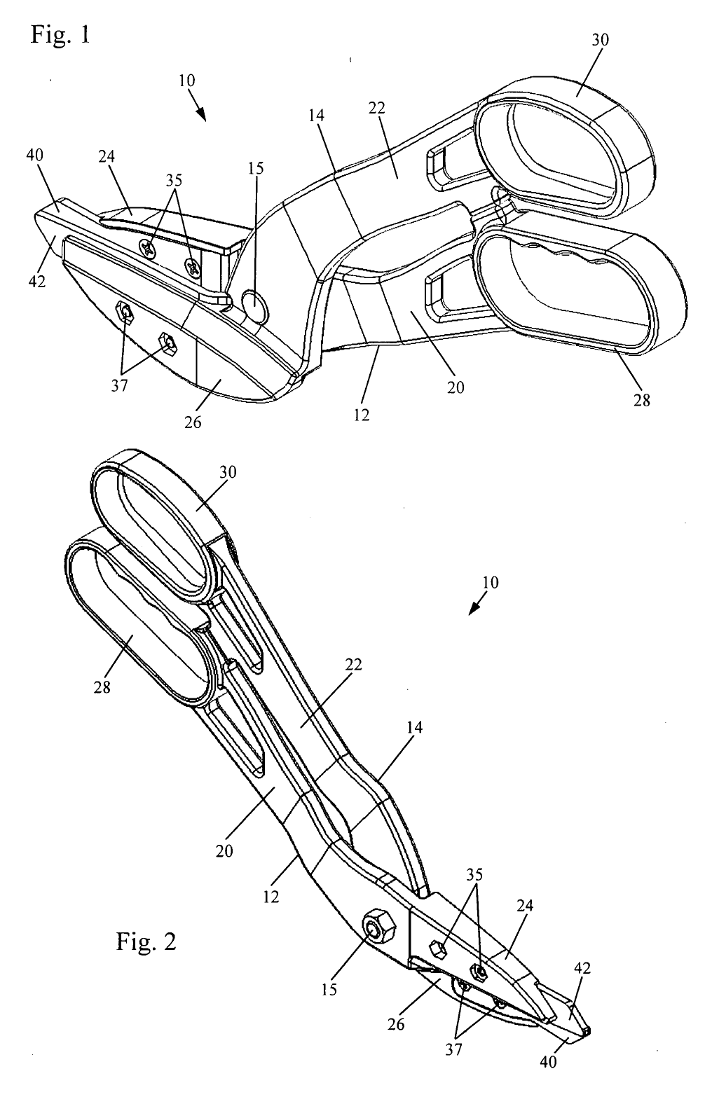

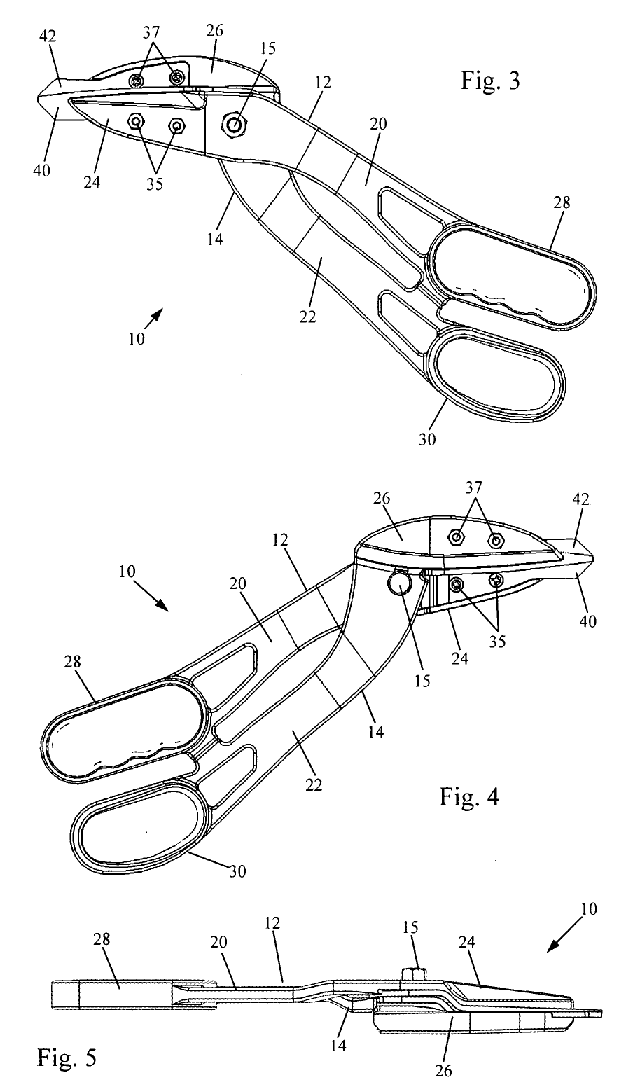

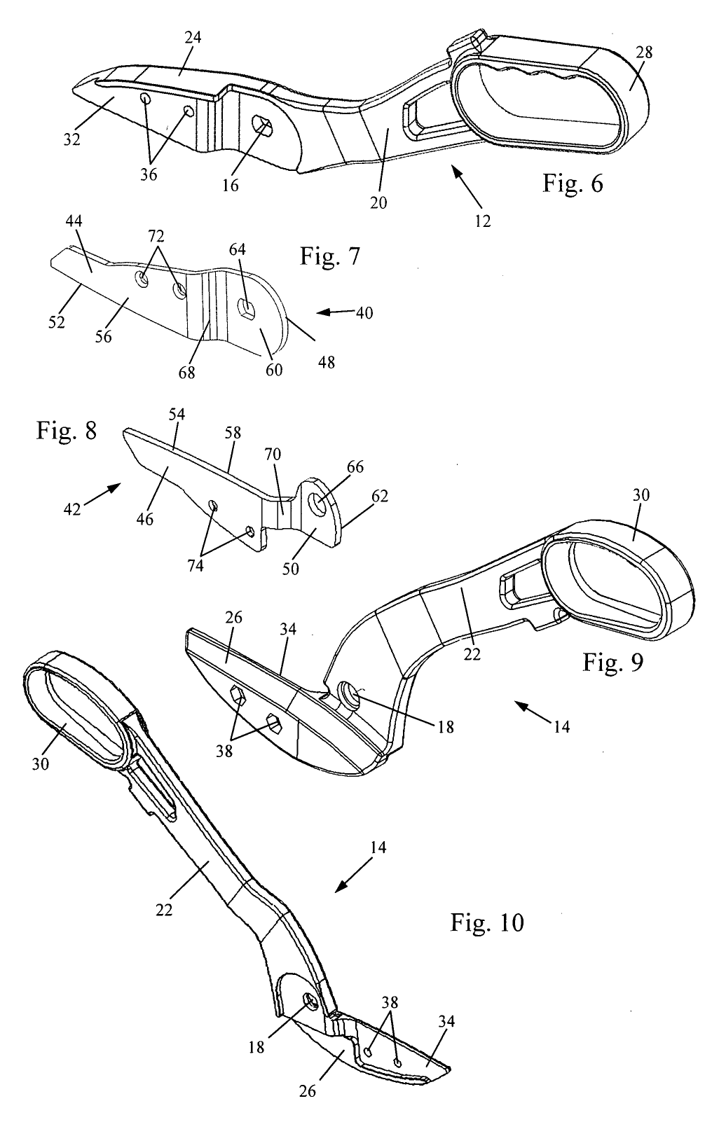

Referring to FIGS. 1-5, an illustrative embodiment of the snips in accordance with the present invention is indicated generally by the numeral 10. The snips embodying the invention are constructed of a pair of levers 12 and 14. The levers are pivotably connected to each other by a pivot fastener 15 that axially engages lever pivot apertures 16 and 18 (shown in FIGS. 6, 9, and 10) for allowing rotational movement of the levers 12 and 14 relative to one another. The pivot fastener 15 consists of a conventional nut-bolt combination, however all other means of rotatably interconnecting the levers 12 and 14 are also contemplated by this invention.

Referring again to FIGS. 1-5, each lever 12 and 14 consists of a hand grip lever arm 20 and 22 and a blade lever-arm 24 and 26 extending in substantially opposite directions from the pivot fastener 15. Each hand grip lever arm 20 and 22 and each blade lever-arm 24 and 26 has a proximal end that is closest to the pivot fastener 15 and a distal end that is furthest from the pivot fastener 15. The hand grip lever arms 20 and 22 have hand grips 28 and 30 at their distal ends which are formed as loops for accepting the fingers and thumb of the operator. The blade lever-arms 24 and 26 have blade-bearing members 40 and 42 (discussed below) secured to them via removable fasteners 35 and 37. The removable fasteners 35 and 37 consist of conventional nut-bolt combinations, however all other means of securing the blade-bearing members 40 and 42 to the blade lever-arms 24 and 26 are also contemplated by this invention.

Referring to FIGS. 6, 9, and 10, each blade lever-arm 24 and 26 is offset from the hand grip lever arm 20 and 22 on the same lever 12 and 14. Offsetting the blade lever-arms 24 and 26 from the hand grip lever arm 20 and 22 results in an offset of the cutting plane from the hand grip lever arms and the hands of the tool's operator. Therefore, when the snips are being operated and a subject material is being cut, the material on either side of the cut bypasses the operator's hand on one side or the other (on the left if the operator is right-handed and on the right if the operator is left-handed) without interference. The levers 12 and 14 are also bent so that the blade lever-arms 24 and 26 extend at an obtuse angle relative to the hand grip lever arms 20 and 22 so that the material being cut passes below or above the hand grip lever arms 20 and 22 and the operator's hands without interference.

Each blade lever-arm 24 and 26 has an inwardly-facing, recessed surface that provides a cavity 32 and 34. Each cavity 32 and 34 extends from the distal end of its respective blade lever-arm 24 and 26 to an area adjacent to the pivot aperture 16 and 18 at the proximal end of its respective hand grip lever arm 20 and 22. The lever pivot apertures 16 and 18 are therefore disposed within the cavities 32 and 34. Additionally, each cavity 32 and 34 has a pair of blade lever-arm mounting holes 36 and 38 extending from it for mounting a blade-bearing member 40 and 42 (discussed below) with a removable fastener.

Blade-bearing members 40 and 42 are shown mounted on the blade lever-arms 24 and 26 in FIGS. 1-5, and are shown unmounted in FIGS. 7 and 8. Referring to FIGS. 7 and 8, each blade-bearing member 40 and 42 is an elongated, unitary body having a blade portion 44 and 46 and a bearing portion 48 and 50. Each blade portion 44 and 46 has a cutting edge 52 and 54 and an inwardly-facing blade surface 56 and 58, both of which face and engage the cutting edge and blade surface of the blade-bearing member on the other lever, respectively. Each bearing portion 48 and 50 has a bearing pivot aperture 64 and 66 for receiving the pivot fastener 15. Additionally, each bearing portion 48 and 50 has a thrust-bearing surface 60 and 62 surrounding the pivot aperture 64 and 66 that rotatably engages the thrust-bearing surface of the bearing portion of the other blade-bearing member.

The blade portions 44 and 46 of the blade-bearing members 40 and 42 are offset from and joined to their respective bearing portions 48 and 50 by a pair of oppositely-directed curved bends 68 and 70, thereby allowing the blade-bearing members 40 and 42 to conformingly mate with the interior contours of the cavities 32 and 34. Additionally, the blade portions 44 and 46 each have a pair of blade-bearing member mounting holes 72 and 74 which axially align with the blade lever-arm mounting holes 36 and 38 on the same lever 12 and 14 when the blade-bearing members 40 and 42 are seated in the cavities 32 and 34. Removable fasteners 35 and 37 engage each pair of axially aligned mounting holes for securing the blade-bearing members 40 and 42 within their respective cavities. While conventional nut-bolt combinations are preferred as a fastening means, all other means for removably securing the blade-bearing members 40 and 42 within the cavities 32 and 34 are also contemplated by this invention. It is also contemplated that the described mounting holes and removable fasteners may be omitted, leaving only the pivot fastener 15 and interior walls of the cavity 28 to hold the blade-bearing members 40 and 42 in place.

Two critical benefits are derived from the configuration described above: (1) the curvature of the blade-bearing members 40 and 42 complement the offset feature of the tool, thereby allowing all of the bearing surfaces of each of the tool's levers 12 and 14 to reside on a single, removable blade-bearing member 40 and 42, which in turn allows convenient, simultaneous replacement of all of the tool's cutting edges and bearing surfaces; and (2) because the inner blade surfaces 56 and 58 and thrust-bearing surfaces 60 and 62 of a blade-bearing member wear at the same general rate, and because the inner blade surfaces and thrust-bearing surfaces are replaced simultaneously when a blade-bearing member is replaced, misalignment of the cutting edges 52 and 54 attributable to uneven wear on the thrust-bearing surfaces 60 and 62 relative to the wear on the inner blade surfaces 56 and 58 should never occur.

In order to replace one or both of the cutting edges 52 and 54 after they become dull or ruined, the pivot fastener 15 is removed from the lever pivot apertures 16 and 18. The levers 12 and 14 are then separated from one another. The removable fasteners 35 and 37, securing one or both worn blade-bearing members 40 and 42 within their respective cavities 32 and 34, are removed and the blade-bearing members 40 and 42 are extracted. New blade-bearing members are then inserted and the snips are reassembled.

Although a left cut version of the invention is shown in the figures, a right cut version is also contemplated. As is well known to the prior art, a right cut version and a left cut version of a snips are simply mirror or reverse images of each other.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An improved, hand operated cutting snips having two levers pivotably connected by a pivot fastener, each lever having a blade lever-arm and a hand grip lever arm extending in generally opposite directions from the pivot fastener, the blade lever-arms being offset relative to the hand grip lever arms, each lever further comprising:
a replaceable blade-bearing member formed as an elongated unitary body conformingly seating against the lever and having a blade portion and a thrust bearing portion, the blade portion having a cutting edge facing and engagable with the blade portion of the other lever, the bearing portion having a thrust-bearing surface surrounding the pivot fastener and rotatably engaging the thrust-bearing surface of the blade-bearing member on the other lever, the blade portion being offset from and joined to the bearing portion by two, oppositely-directed, curved bends.

2. A snips in accordance with claim 1, wherein the blade-bearing members are removably fastened to the blade lever-arms.

3. A snips in accordance with claim 2, wherein the thrust-bearing surfaces of the blade-bearing members are parallel with the blade portion.

4. A snips in accordance with claim 2, wherein the blade lever-arms and the blade-bearing members each have at least one hole, each blade lever-arm hole being axially aligned with a corresponding blade-bearing member hole for accepting a removable fastener.

5. A snips in accordance with claim 2, wherein each blade lever-arm has a cavity extending along its interior and into the handle for matingly receiving a blade-bearing member.

6. A snips in accordance with claim 2, wherein the blade lever-arms are bent relative to the hand grip lever arms.

7. A snips in accordance with claim 2, wherein the bearing portions of the blade-bearing members have axially aligned apertures through which the pivot fastener extends.

8. A snips in accordance with claim 7, wherein:
(a) the blade lever-arms are bent at an obtuse angle relative to the hand grip lever arms;
(b) the bearing portions of the blade-bearing members have axially aligned apertures through which the pivot fastener extends;
(c) the thrust-bearing surfaces of the blade-bearing members are parallel with the blade portion;
(d) the blade lever-arms and the blade-bearing members each have at least one hole, each blade lever-arm hole being axially aligned with a corresponding blade-bearing member hole for accepting a removable fastener; and
(e) each blade lever-arm has a cavity extending along its interior and into the hand grip lever arm for matingly receiving a blade-bearing member.
